(19) United States
(12) Patent Application Publication
(10) Pub. No.: US 2025/0157072 A1
(43) Pub. Date: May 15, 2025

(54) Techniques For Real-Time Estimation And Visualization Of Muscle Activations

(71) Applicant: Julian Cloud Ng-Thow-Hing, Los Altos, CA (US)

(72) Inventor: Julian Cloud Ng-Thow-Hing, Los Altos, CA (US)

(21) Appl. No.: 18/388,931

(22) Filed: Nov. 13, 2023

(51) Int. Cl. G06T 7/73; G06N 3/0442

(52) U.S. Cl. CPC G06T 7/73; G06N 3/0442; G06T 2207/10016; G06T 2207/20084; G06T 2207/30196

(57) ABSTRACT

Techniques are disclosed for estimating the activity or activation levels of muscles of a subject. The estimation can be done at real-time or near real-time rates in response to live performance of body motions of the subject. The estimates are computed by a machine learning model which is preferably a long short-term memory (LSTM) recurrent neural network (RNN). The LSTM RNN computes the estimates as output based on 3D pose estimates of the subject as input. The muscle activation estimates can be used to visually express which muscles are active on a display interface such as that of an augmented reality (AR) system. They can also be used to actuate or control other devices such as lighting in smart clothing or prosthetic devices worn by the user. They can also be used to actuate external robotic mechanisms.

### FIELD OF THE INVENTION

This invention generally relates to the fields of biomechanics, physical therapy, rehabilitation, fitness training and exercise. More specifically, the invention relates to estimating and visualizing muscle activity in a subject in real-time.

### BACKGROUND

The need to improve understanding of how the human body works and its relationship to fitness and muscle development is important for successful health care and maintenance. Engaging proper muscles in an exercise is extremely important in athletic training, physical therapy, and workplace ergonomics in order to optimize muscle growth and reduce risk for injury. Both experts and non-experts are often not fully aware of the relationship between training and how it alters the biomechanics of the body.

It is important to be able to observe how the body and more specifically its various muscles respond to various physical motions and exercises.

When it comes to estimating and visualizing such a response of the body and specifically its muscle activity, there is plenty of prior art and with multitude of shortcomings. U.S. Patent Publication No. 2022/0072381 A1 to Trehan teaches a method and system for training users to perform physical activities. The method includes capturing real-time video of the user performing the activity based on an activity option selected by the user. The method also includes extracting an artificial intelligence (AI) model based on the activity option and processing in real-time, by the AI model, the real-time video of the user to determine a set of user performance parameters based on current activity performance of the user.

The above method further includes overlaying, by the AI model, the user in the real-time video with a pose skeletal model. The method also includes comparing, by the AI model, the set of user performance parameters with a set of target activity performance parameters. The method further includes generating, by the AI model, feedback for the user based on comparison of the set of user performance parameters with the set of target activity performance parameters. Their method finally includes rendering, by the AI model, the feedback above on a rendering device.

U.S. Patent Publication No. 2022/0277845 A1 to Liu discloses an application that provides a prompt method for fitness training and an electronic device. Their method includes obtaining required training space, where the required training space is used to complete one or more training actions. The method further includes determining, based on a training scenario in which a user is located and the required training space, a training location recommended to the user. The method also includes recording a training action of the user based on the training location recommended to the user. A suitable training location is recommended to the user based on the training scenario in which the user is located and the required training space. Therefore, the user can also normally perform training in a scenario in which exercise space is limited, for example, when there is an obstruction or a site is insufficient.

U.S. Patent Publication No. 2023/0137222 A1 to D'Ambrosio-Correll discloses an apparatus that includes a first weight plate, a second weight plate, and an elongate, substantially cylindrical handle. The first weight plate assembly includes a first pair of endplates and a first over-molded weight. The second weight plate assembly includes a second pair of endplates and a second over-molded weight. The handle is mechanically coupled at a first end to the first weight plate assembly and at a second end to the second weight plate assembly. At least one of the first weight plate assembly or the second weight plate assembly includes at least one light-emitting diode (LED). A transparent or translucent numerical indicator is associated with a total weight of the apparatus. Through the indicator, a light emitted from the at least one LED is transmitted when the at least one LED is activated.

U.S. Patent Publication No. 2006/0286522 A1 to Ng-Thow-Hing teaches a system and method for animating a character with activation-driven muscle deformation. External loads in the system can be estimated through an iterative joint torque estimation process, and the external loads reflected in a physical model. Kinematic motion and the physical model reflecting external loads can be used to estimate joint torques by their system. Muscle activations can be determined from the joint torques, and a character can be animated with muscle deformation responsive to the muscle activations

U.S. Pat. No. 9,161,708 B2 to Elliott teaches the use of motion capture data for analyzing the performance of an individual for certain exercises. With their techniques, one can compare movement data for an individual with a database of recorded motions for a population. As a result, one can generate a training regimen for the individual and for monitoring their progress while carrying out the training regimen.

U.S. Pat. No. 11,350,854 B2 to Myer teaches an augmented neuromuscular training system and method for providing feedback to a user in order to reduce movement deficits associated with injury risk, prior injury or disease pathology.

Despite the abundance of prior art, there are not any prevailing techniques that estimate muscle activations in a subject on a real-time or near real-time basis. The prior art techniques are not able to accomplish this objective at high granularity or level of detail or by using a machine learning model. Many prior art techniques require the subject to necessarily wear sensors. They also cannot detect muscle activity for internal muscles without invasive procedures.

Some prior art techniques require pre-recorded and pre-captured motion and are restricted to modeling the muscle deformation effects on the skin of the body. Furthermore, for recovery and rehabilitation, traditional solutions require multiple physical therapy sessions involving paid experts, having to schedule appointment times and traveling to the trainer's premises. These add cost and inconvenience to the user. As a result, physical therapy plans for treatment are often neglected or ignored or not done properly.

In the prevailing techniques, there are challenges for properly obtaining information about muscle activations in a subject at least for the following reasons:
1. Muscles form complex assemblies and attachments via tendons attached to the bones of the skeleton. These muscles are packed together tightly within the body under layers of skin, fatty tissue and other connective tissue. Direct sensing and measurement of activation of muscle cells from the nerves serving them is technically difficult, requires invasive surgery and advanced signal processing to remove noise. Further, any presence of physical sensors likely influences proper functioning of muscles as the sensors would impede movement or even cause discomfort for the subject with the sensors installed on them.
2. Superficial sensors like Electromyography (EMG) require expert placement of the sensors on the skin and the application of a conductive gel that is uncomfortable for the subject. The sensor contact with the skin is subject to external movement vibration and noise as well as impedance of motion due to the adhesives and wires involved in their use. This prevents natural motion and restricts the environmental conditions of their use. Any solution that requires wearing biometric sensors also needs to address power supply to those sensors, as well as provisioning control units for the sensors. The control units would enable the sensors to capture, store and transmit data to computers or computing units for processing. Further, transmission requires restrictive tethered cables connecting the computer to the sensors that prevent free movement. If no wires are desired, wireless protocols to minimize data loss and latency are required.
3. Depending on the application, different levels of granularity in resolving the activation of muscles is required. Although in some cases, large muscle groups can be aggregated together for general fitness training, a rehabilitation scenario generally requires precise estimates of individual muscles. These are essential for predicting how other muscles may adjust their own activity to compensate for a weaker or impaired muscle.
4. Some subjects for motion study may be difficult or dangerous to work with. Small children incapable of understanding human speech or intentions may be fearful or uncooperative in wearing physical sensors. If the subjects are animals, they may not only be fearful but they may also try to actively remove the sensors, preventing any analysis of the motion. With large wild animals, working with instrumentation on their bodies can be dangerous or impossible. Any placement of sensors would only be possible if the subject is under sedation (which would circumvent normal movements) or the animal may have to undergo lengthy training to acclimatize to the devices. The latter would be expensive in training time, require specialized and skilled workers, and not likely be an accurate indicator of natural motion patterns of the animal.

### OBJECTS OF THE INVENTION

In view of the shortcomings of the prior art, it is an object of the invention to provide techniques for estimating muscle activations or activity in a subject on a real-time basis while the subject is performing a physical motion or exercise.

It is also an object of the invention to use a recurrent neural network (RNN) as the machine learning model (MLM) for estimating the muscle activations.

It is further an object of the invention to estimate muscle activations by MLM/RNN by processing as input three-dimensional (3D) pose estimates of the subject.

It is also an object of the invention to use a pose estimator to compute or estimate the 3D poses of the body segments of interest of the subject.

It is also an object of the invention to not require the subject to wear sensors either superficially or via surgical implants.

It is further an object of the invention to use the estimated muscle activations for various types of expressions by various response modules or systems.

Still other objects and advantages of the invention will become apparent upon reading the summary and the detailed description in conjunction with the drawing figures.

### SUMMARY OF THE INVENTION

A number of objects and advantages of the invention are achieved by apparatus and methods for capturing sensor data of a subject in motion and estimating muscle activations in the subject on a real-time or near real-time basis. For this purpose, a pose estimator is used to estimate three dimensional (3D) poses of the subject by analyzing the sensor data. The pose estimator generates the 3D poses of various body segments of interest in the subject as a time-series.

A machine learning model (MLM) processes the 3D poses generated by the pose estimator as an input time-series, and produces estimates of muscle-related activity or muscle activation or muscle activity in the subject as an output time-series. For this purpose, the MLM is first trained on training data comprising various inputs of pose estimates for the same subject or for various subjects, and corresponding output of muscle activations in the subject(s). At least in part, the training data comprises simulated data. Muscle activations represent the amount of muscle force-generating activity with the fibers that make up the muscle. In humans and animals, muscle activity is controlled by signals from the motor neurons of the nervous system for controlling body segment motions.

In various preferred embodiments, the pose generated by the pose estimator is a relative pose of the body segment with respect to a parent body segment. In the same or related set of preferred embodiments, the sensor is a camera or a set of cameras and the sensor data is a motion video.

In the same or related set of preferred embodiments, the MLM is a recurrent neural network (RNN). The RNN is preferably a long short-term memory (LSTM) RNN. Advantageously, the input pose estimates are processed by MLM or RNN or LSTM RNN using or via a sliding window of the time-series of poses with an offset into the sliding window. The optimal offset into the sliding window is preferably experimentally determined. Based on the instant techniques, muscle activation estimates can thus be produced at a rate of greater than or equal to 24 Hertz (Hz).

In various preferred embodiments, along with the muscle activation estimates, ground reaction forces on the subject are also estimated. In the same or related embodiments, these estimates of muscle activation or ground reaction forces are mapped to respective state vectors. In the same or related embodiments, the estimates directly themselves or their state vectors are inputted to a variety of response systems or modules for various expressions of muscle activity/activation estimates.

Such response modules/systems include an audio-visual response module that produces a visualization and/or a sound output based on the muscle activation estimates. The visualization is preferably produced on a screen. Depending on the embodiment, the screen may belong to a video playback system or a desktop computer system or a mobile computing device or a computer/computing tablet or a wearable augmented reality (AR) display or a head-mounted AR display or a reflective mirror, among others.

In still other embodiments, the audio-visual response module generates a character animation based on the muscle activation estimates and/or their state vector. In still other embodiments, the audio-visual response system uses light emitting diodes (LEDs) or other lighting elements for visualization. In other embodiments, the response system produces a sound based on its input, which is preferably a musical sound or even a linguistic or phonetic sound.

In still other embodiments, the response module/system is a mechanical response module. Preferably, the mechanical response module is a wearable clothing item, such as an exoskeleton suit with attached light emitting diodes (LEDs) that are lighted up for visualization. A response module containing both mechanical and audio-visual expressions may be considered to be either or both of an audio-visual and a mechanical response module.

In still other embodiments, the mechanical response system is a wearable prosthetic device that is actuated based on the muscle activation estimates and/or their corresponding state vector. In still other embodiments, the mechanical response system is a haptic device or a vibration device that is activated based on the muscle activation estimates and/or the corresponding state vector.

The systems of the present technology comprise (a) a camera for capturing a motion video of a subject, said subject comprising a body segment and a muscle, (b) a pose estimator for analyzing said motion video and for generating a time-series of three-dimensional (3D) pose estimates of said body segment, wherein said pose estimates are relative to a parent body segment, and (c) a trained recurrent neural network (RNN), wherein said trained RNN receives said time-series and generates an estimate of an activation of said muscle.

The systems of the present design further comprise (a) a sensor for generating sensor data by sensing a motion of a subject, said subject comprising a body segment and a muscle, (b) a pose estimator for analyzing said sensor data and for generating a time-series of three-dimensional (3D) pose estimates of said body segment, and (c) a trained recurrent neural network (RNN), wherein said trained RNN receives said time-series and generates an estimate of an activation of said muscle.

The methods of the present technology comprise the steps of (a) capturing a motion video of a subject by a camera, said subject comprising a body segment and a muscle, (b) analyzing said motion video by a pose estimator and generating by said pose estimator a time-series of three-dimensional (3D) pose estimates of said body segment relative to a parent body segment, and (c) processing said time-series by a trained recurrent neural network (RNN) and generating by said trained RNN an estimate of an activation of said muscle.

Clearly, the system and methods of the invention find many advantageous embodiments, of The details the invention, including its preferred embodiments, are presented in the below detailed description with reference to the appended drawing figures.

### BRIEF DESCRIPTION OF THE DRAWING FIGURES

FIG. 1A shows the preferred embodiment of a muscle activation system based on the present principles that uses a camera to capture the motion video of a subject as input to the system.

FIG. 1B is a generalized variation of the embodiment of FIG. 1A that uses sensors to generate sensor data based on the motions of a subject as input to the system.

FIG. 2A shows another preferred embodiment that uses cameras and/or sensors to capture the motion of a subject. The embodiment also includes an audio-visual response module and a mechanical response module.

FIG. 2B is a variation of the embodiment of FIG. 2A that utilizes a pose sequence cache.

FIG. 3 shows a fixed world coordinate system with a ground frame on the ground floor and a root joint chosen to be the pelvis of the body of a subject.

FIG. 4 illustrates the concept of a sliding window and an offset within the sliding window as used by an instant machine learning model (MLM).

FIG. 5 shows a visualized output of the present technology in which muscles superimposed on a skeleton are color-coded based on the level or degree of activation of the respective muscles in a subject.

FIG. 6 shows a visualized output of the present technology in which the muscles are abstracted as piece-wise line segments that are color coded based on muscle activation estimates.

FIG. 7 shows embodiments that take advantage of sensors placed on or worn by the subject.

FIG. 8 shows an embodiment with time series of poses as input into to an LSTM RNN for estimating muscle activations at a given instant of time.

FIG. 9A-D show four successive top-down portions/sections of a multi-layered LSTM RNN or simply a multi-layered LSTM network of the present design.

FIG. 10A shows the performance of an underfitted MLM.

FIG. 10B shows the performance of an overfitted MLM.

FIG. 11 shows the performance of a properly generalized and trained MLM of the present technology.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

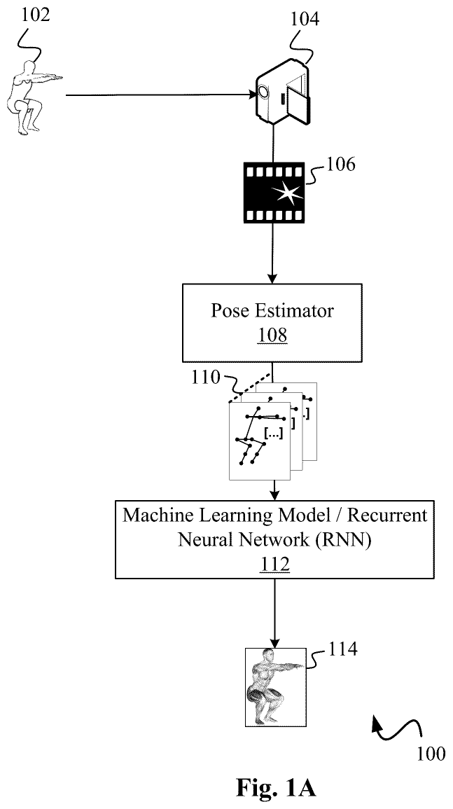

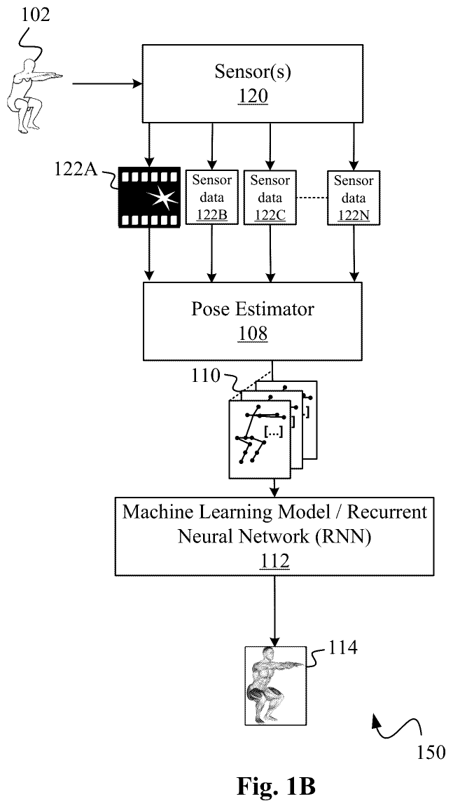

Let us now review a muscle activation estimate system 100 based on the present principles by taking advantage of FIG. 1A. System 100 shows a camera 104 filming or taking or capturing a motion video 106 of a subject 102 who is performing a motion or a physical activity or an exercise. Exemplarily, subject 102 is a human being, although it can be any animal of the Animal Kingdom that has one or more body segments and one or more muscles or muscle tissue. Motion video 106 captured by camera 104 is being provided as input to a pose estimator subsystem or module 108. Pose estimator in turn generates a time series 110 of 3D pose estimates of one or more body segments of interest of/in subject 102 performing the motion/physical activity/exercise.

Further, there is a Machine Learning Model (MLM) 112, which is preferably a Recurrent Neural Network (RNN) that takes as input time series 110 of pose estimates of subject 102. In turn as its output, MLM or RNN 112 produces one or more estimates 114 of the muscle-activity or activations levels or simply activations of/in one or more muscles of interest of/in subject 102. The present technology is able to accomplish this at real-time or near real-time speeds/rates equal to or exceeding 24 Hertz (Hz) or 24 successive estimates of the activation of one or more muscles of interest per second. For the purposes of this disclosure, we consider real-time to be a rate equal to or faster than 24 Hertz (Hz) or 24 times per second or 24 frames per second—which is the standard cinematic frame rate in North America.

Along with estimates 114 of muscle activations, other useful biometric data about subject 102, including ground reaction forces, can also be derived based on the present principles. The present technology is able to achieve this while not requiring invasive sensors or other inconvenient methods of the prior art. The ability to receive estimates of muscle activation in real-time allows both subject or user 102, and optionally an investigator or observer (not explicitly shown), to obtain immediate feedback about muscle activity and other biomechanical motion metrics about the subject.

The faster the frame rate at which motion video 106 is processed by system 100 to produce muscle activation estimates 114 per above, the smoother the results and greater the temporal resolution or time granularity of observed detail. This allows subject 102 to quickly adjust their actions and observe the consequent changes in their motion metrics. This in turn allows them to associate exercise or physical training/lessons to the activation of various muscles, thereby resulting in improving the effectiveness of the exercise. This further provides a valuable mechanism for correcting problems and errors in the motions or body movements for performing various tasks.

The preferred embodiment uses a camera 104 as shown in FIG. 1A. It should be understood that multiple such cameras may be present that capture motion videos of subject 102 from various viewpoints. These one or more motion videos 106 are then provided as input to pose estimator 108 that produces times series 110 of the pose estimates of various body segments of interest in subject 102. In addition to or besides cameras, any other types of sensors may be utilized that sense the biomechanical motion of subject 102 and produce corresponding motion sensor data.

Such a sensors-based embodiment as a variation of camera(s) based embodiment 100 of FIG. 1A is shown in FIG. 1B. FIG. 1B shows a muscle activation estimation system 150 of the present design that uses sensors 120. Sensors 120A, 120B, . . . , 120N or simply sensors 120 may comprise one or more cameras as in system 100. Further, sensors 120 may comprise any other types of sensors including inertial or inertial measurement unit (IMU) sensors including accelerometers, gyroscopes, magnetometers, barometers, temperature sensors, depth sensors, GPS receivers, among others. Each of such sensors produces respective sensor data based on the motion of subject 102. This sensor data is then consumed by pose estimator 108 in order to produce time series 110 of pose estimates discussed above.

In the example shown in FIG. 1B, sensors 120 include camera(s), hence there is sensor data 122A which is a motion video or videos. Sensors 120 include other sensors such as the ones mentioned above. Hence, there are respective sensor data streams or sensor data labeled 122A, 122B, . . . , 122N produced by these sensors. Note that sensor data 122A is motion video(s) captured by one or more camera amongst sensors 120. Any number and types of sensors 120 may be placed on the body of or be worn by subject 102.

As per the embodiment of FIG. 1A, pose estimator is in charge of producing time series 110 of pose estimates of various body segments of interest of/in subject 102. The rest of the processing in system 150 of FIG. 1B continues as in system 100 of FIG. 1A, thus producing one or more estimates 114 of the activation of the muscles of interest in subject 102. Muscle activations represent a significant new modality of information helpful to analyze motions. They are important because muscles are the prime motivators of motions in humans and animals and a better understanding of muscle activation allows improved training and injury prevention.

Depending on various embodiments of the present technology, estimates 114 of muscle activations and other biometrics of/in subject 102 can be utilized and expressed in many different ways.

In some embodiments, these are fed into a visual response module or subsystem or system whose expression is a visualization on a visual display. The display may be an external monitor, a portable computing tablet display, a mobile device display, a head-mounted display, among others.

In other embodiments, estimates 114 are fed into an audio response system or speakers that produce a sound or music based on estimates 114. In still other embodiment, estimates 114 are used to create control signals for or to drive a mechanical response module/system for mechanical expression of muscle activation. The mechanical response module includes a physical mechanism that is actuated by such control signals.

Examples of an instant mechanical response module include a worn exoskeleton, a limb prosthetic, a standalone robotic device, an item of smart clothing with light or haptic feedback, among others. Smart clothing refers to items of clothing embedding any variety of active or passive devices and sensors including haptic sensors and/or light-emitting diodes (LEDs). Therefore, such a response system may be considered to be a visual response system or a type of an audio-visual response system also.

The main distinguishing features of the present technology include:
Real-time, or near real-time muscle activation estimation, providing immediate feedback to the subject or to an investigator of the system.
The present design is non-invasive and does not require any sensors to be worn by the subject/user. However, depending on the embodiment, sensors may be placed on or be worn by the subject.
The present technology does not place any constraints on the location where motion by the subject is performed. Exemplarily, it can be in a park, in a backyard, at home, in a gym, among other locations.
The present technology can also be used to estimate ground reaction forces on the subject to aid in further motion analysis. This and other biometric estimates generated as a consequence of the present design can then be used to generate additional metrics including effort, limb stiffness and fatigue.
Based on the present techniques, muscle activity can provide a higher granularity or resolution of biomechanical motion of the subject than mechanical or Electromyogram (EMG) sensors.
Further, the present techniques can estimate the activity or activation of surface as well as internal muscles.
In contrast to prior art systems that are only body pose-based or kinematics-based (position-based), the present design generates muscle activation estimates that are based on neuromuscular activity of the subject. The neuromuscular activity is in turn related to the dynamic force generation properties of muscles for creating motion.
Using the present techniques, estimates of muscle activations allow one to measure properties that cannot be easily obtained from just kinematic data. For example, co-contraction of muscle can be used to determine limb stiffness or joint stability. Muscle activity allows estimation of derived metrics such as effort, fatigue, limb stiffness and tension which cannot be obtained with purely kinematics or body pose-based systems.
Muscle activation estimates derived using the instant principles are more prescriptive to humans because they address the direct causal factors of motion and are the prime motivators of motion. Knowing which muscles to activate can create, stabilize or restrict body motion, thus allowing a specific muscle training program to be prescribed for a subject.
As will be described further below, training data for the instant machine learning model (MLM) is obtained from musculoskeletal simulation and optimization techniques for estimating muscle forces for motion. This can be done using muscle simulation software such as OpenSIM. Training based on an accurate model of the subject allows greater internal biomechanical knowledge to be incorporated. This includes muscle geometry configuration, body segment mass and shape distribution. The training can thus be specialized for the subject and allows the creation of subject-specific MLMs to be used in production or for the generation of runtime estimates of muscle activation/activity of the subject.

The present technology estimates muscle activations, and ground reaction forces from a series of poses of body segments over time. Muscle activations require estimates of muscle forces and neural-excitation dynamics relating activation to the muscle force generated. Muscles can also co-contract on both sides of a joint, so it is possible for different configurations of muscle activations to be present for the same body pose, depending on what external loads and current velocity and accelerations are acting on the body. For example, a muscle can actively generate force in an opposite direction to an observed limb motion in order to stabilize or to slow down the limb.

The present design can analyze any type of body motion. The motion does not need to be cyclical as in some prior art techniques. However, the present technology can also analyze cyclical motions and produce estimates for activations and ground reaction forces under those conditions. The estimation of muscle activations in the present design is based on a trained machine learning model which is preferably a trained recurrent neural network (RNN). It can produce a finer granularity of muscle activity resolution, including estimating the activations of internal muscles that cannot be measured with just externally mounted sensors. The present technology can estimate individual muscles as well as aggregate muscle activity in various muscle groups such as the hamstrings or the quadriceps.

The present design also allows motions to be performed in a wider variety of environments since there is no need to avoid magnetic fields as in the case of inertial measurement units (IMUs) and other magnetic-based trackers. The subject also does not need to be near or be connected to a power source. Instead, based on the instant principles, an image sensor such as camera 104 of FIG. 1A is used to provide non-contact sensing from an observation point away from the subject.

The camera in the instant design can be either stationary or moving. This freely held camera capability allows the motion to be observed from multiple viewpoints. Such a design also does not place any constraints on the subject as to where they need to be located. The present technology focuses on the movement of body limbs (lower and upper extremity) for the subject. The subject can be a human or animal, and therefore does not require human-specific parameters, motions or exercises. The present technology can be used to analyze the motion of wild animals in their natural habitats and out of a laboratory.

The present technology focuses on the change of body segment pose that happens in the skeleton as muscles contract to create motion in the bones. The input to the MLM for estimating muscle activations can be in the form of 3D poses of body segments. Poses can consist of positional and/or orientation information. The present technology can also work only with body segment orientations as input to MLM or RNN 112 of FIG. 1A-B i.e. without requiring translations. Of course, it can also optionally include as input the full 6 degrees of freedom (DOF) pose of the pelvis of a human subject to properly pose the pelvis with respect to the ground.

In some embodiments, images or motion video from camera 106 can be directly input into an MLM for producing 3D pose estimates, and without requiring identification of specific key-points on the image first. In any case, time-series 110 of FIG. 1A-B of 3D pose estimates for each body segment of interest are then input to MLM/RNN 112 for efficiently computing muscle activation estimates. Depending on the embodiment, MLM/RNN 112 of FIG. 1A-B can also optionally estimate ground reaction and joint reaction forces. A highly preferred embodiment of MLM/RNN uses a long short-term memory (LSTM) RNN.

The present design uses four-dimensional (4D) quaternions for compactness in representing 3D pose orientation estimates. The muscle activations are mapped to state information that is then used by a visual response module and/or an audio response module and/or a mechanical response module, and the like. The above state information is represented as a state vector for producing control signals that drive the above response modules or systems.

The present technology generates a computationally-efficient model using machine learning to compute muscle activations and/or ground reaction forces on the body, given body segment pose inputs derived from sequence(s) of body motion over time. The sequence(s) of motion capture the spatiotemporal trajectory of motion over a fixed time span and are ultimately used to infer the likely consequent muscle activations.

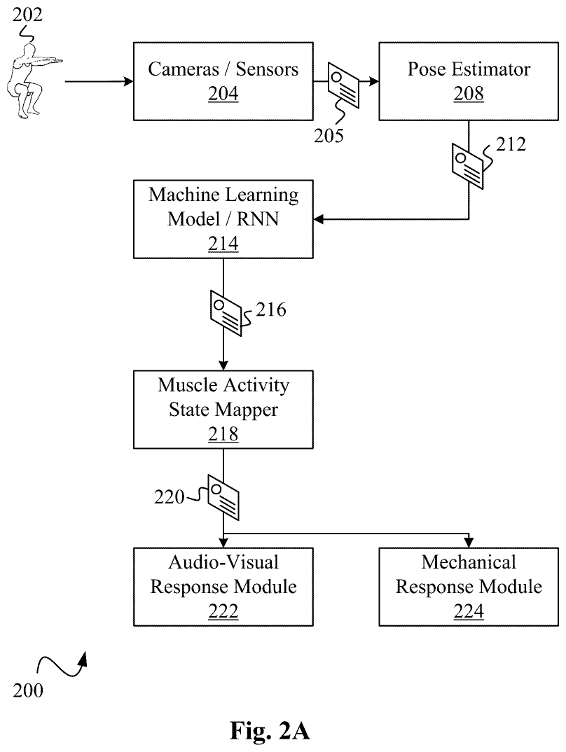

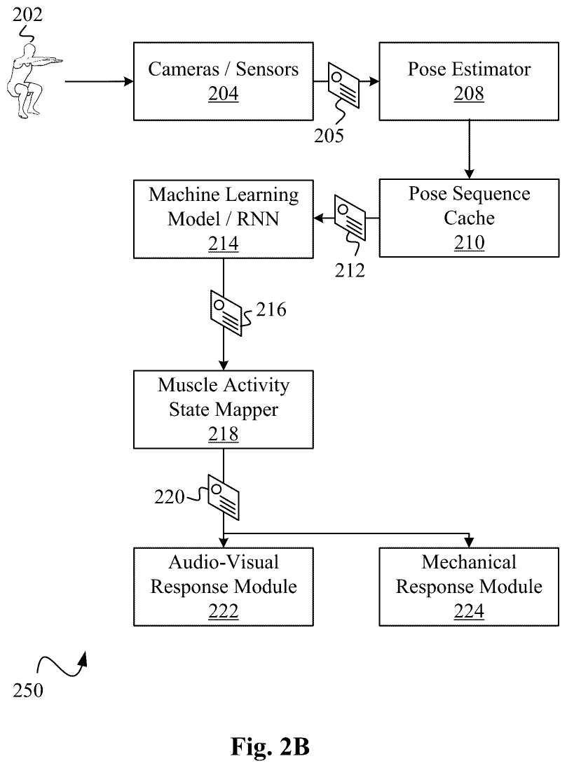

Let us now review additional embodiments of the present technology by taking advantage of FIG. 2A that shows the block diagram of a muscle activation estimation system 200 based on the instant principles. Note first that the various teachings provided herein apply to the embodiments of FIG. 1A-B discussed above as well as those of FIG. 2A-B taught below. In FIG. 2A, subject 202, exemplarily a human being is performing a physical activity or exercise as shown. In a highly preferred variation, the subject activity is being captured by a camera 204 as a series of images or as a motion video 205. Motion video 205 is then provided as input to pose estimator 208. In alternative embodiments, in addition or instead of the camera, there are sensors that sense the physical activity of subject 202 and provide their measurements or readings or sensor data 205 to pose estimator 208.

A configuration setting provided to system 200 informs pose estimator 208 as to which body segments of subject 202 are of interest and need to be tracked. Exemplarily, this configuration setting can be provided as a set or as a list or as a vector B of integers j=1, 2, . . . , m or indices each of which uniquely identifies a body segment of subject 202. These can also be provided as a list or as a vector of the names of body segments. The above list/vector can be provided via a configuration file or via a user interface or other like techniques. As a result, pose estimator 208 tracks or estimates the pose of those body segments of subject 202 that are specified/identified in the configuration.

The determination of how many and which body segments are to be tracked by pose estimator 208 depends on the application of system 200. The decision involves a trade-off between accuracy and computation time/cost. The greater the number of body segments used, the larger the number of muscles involved whose activities/activations can be estimated. Consequently, the higher the computation time/cost required by MLM/RNN 214 and in turn by system 200 to compute the muscle activity estimates. This is at least because the number of training iterations required by MLM/RNN 214 to learn its parameters is larger.

Pose estimator may be implemented using a variety of techniques. These also include those also that internally employ machine learning. Examples of pose estimators available in the industry include ARKit by Apple™, OpenPose and Xnect™, among others.

Based on the above-discussed configuration, pose estimator module 208 generates a time-series X of vectors or lists Xᵢ of poses of body segments of interest configured. Each vector Xᵢ consists of entries Xⱼᵢ of pose estimates or simply poses of body segments j or interest. Here, subscript j denotes body segment j whose pose is being tracked or in other words a body segment of interest, while subscript i denotes the index i of the pose estimate sample taken at time tᵢ. Exemplarily, index/position 4 in vectors Xᵢ in time-series X may represent the lower left leg, index/position 5 a foot bone, and so on.

Per above teachings, each value of subscript j corresponds to an entry in list/vector B, where j=1, 2, . . . , m, and m represents the number of body segments or bone segments of interest. In the preferred embodiment, set B is a hyperparameter to MLM/RNN 214 and stays unchanged throughout the training of MLM/RNN 214 as well as during inference/predictions at runtime. B is provided as a configuration option to the system per above teachings.

The number of body segments in B being tracked can be configured or chosen or adjusted according to the requirements of an implementation. These requirements would also dictate the level of detail or granularity required while estimating/collecting pose estimates of various body segments, and providing those estimates in vectors Xᵢ as input samples to model 214. In one implementation, B may be defined to include the pelvis, upper leg, lower leg, and foot segments in both legs. In another implementation, it may also include upper body segments.

Let us now review the above workings of the present technology with even greater rigor. Pose estimator 208 generates a finite and uniform time-series X of output pose estimate vectors Xᵢ at time instances tᵢ, where i=1, 2, . . . , n. Per above, X represents uniform time-series data, and each sample Xᵢ in X represents the body pose estimates with entries Xⱼᵢ taken at timestamp tᵢ for all body or bone segments j in B.

These pose estimate vectors or simply pose estimates Xᵢ in time-series X serve as the input samples to machine learning model 214 per below explanation. Since X represents uniform time-series data, each sample Xᵢ in X has an associated timestamp indicating the time when the sample was taken. This is the time at which the motion or the position and orientation of subject 202 is expressed by pose estimate vector Xᵢ. Pose estimate time-series X is marked by reference numeral 212 in FIG. 2.

In the preferred embodiments, pose estimates in time-series X are relative pose estimates of respective body segments with respect to (w.r.t.) a reference point on subject 202, rather than absolute pose estimate values w.r.t. a world reference frame. In the preferred embodiments, the reference point is a reference body segment or joint of subject 202. In the same or related embodiments, the reference body segment or joint of a given body segment is its parent body segment or joint. The parent body segment or joint of a given body segment/joint is preferably chosen as the body segment/joint that is proximal (rather than distal) to the given body segment/joint.

As per standard literature in neuromuscular teachings, the proximal body segment/joint is the one closer to the torso of subject 202 and the distal body segment/joint is the one farther away from the torso. Thus, the reference or parent body segment for lower leg would be the upper leg, and the reference joint would be the knee. The advantages of choosing relative poses for time-series X as opposed to an absolute pose w.r.t. a fixed set of world coordinates or world reference frame or ground frame, include higher compactness of representation and computational efficiencies.

For most biomechanical joints, we can assume negligible translation between the bones and ignore the translational coordinates of the joint, allowing only rotational values of the relative pose estimates to be represented and consequently a more compact representation of body segment pose. However, there are cases when translational coordinates may be desired and included, such as if joint dislocation is to be modeled. Another scenario would be if some joints such as the knee and parts of the shoulder undergo sliding or translational movement and the ability to estimate that motion is needed for the application.

Furthermore, in any hierarchy of joints, there is typically a single designated root joint which is often located at a reference point on the pelvis. The root joint requires both position and orientation/rotation to be represented to properly place and configure the body of the subject with respect to the environment.

So, the root joint is specified by an absolute pose in terms of position and orientation/rotation relative to a fixed frame in the environment. The environment is also often referred to as the ground or world frame. The root joint is preferably chosen to be located at the pelvis.

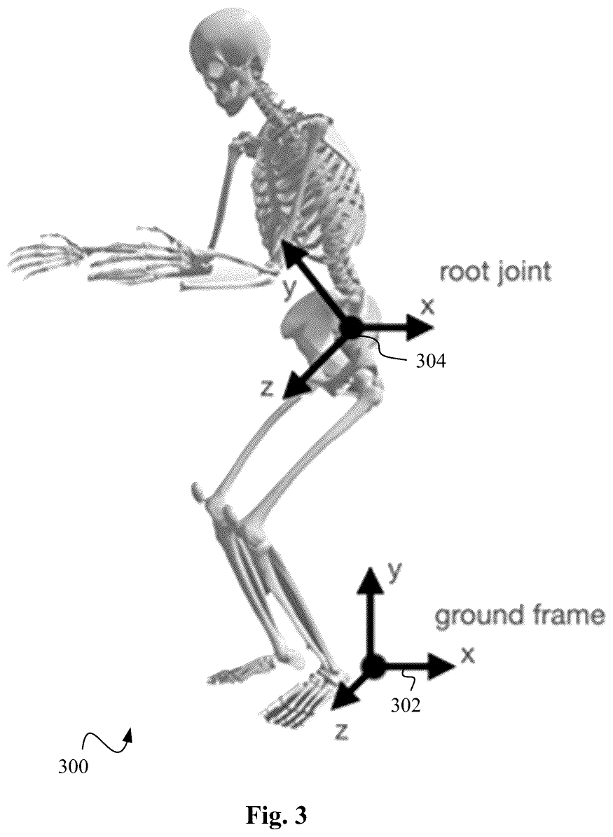

FIG. 3 shows such a fixed world coordinate system 300 with a ground frame 302 on the ground floor and root joint 304 chosen to be the pelvis as shown on the skeleton. Typically, the pelvis is chosen as the root joint or root body segment because it represents the position and orientation of the entire skeleton. The rest of the body segments or bone segments are typically represented relative to the proximal body segment adjacent to the common joint between them, referred to as the parent joint. Consequently, and transitively, all the other body segments end up being relative to the root joint. As noted above, the proximal joint or segment relative to a given joint/segment is the one closer to the torso.

Per above, the advantages of using relative poses with respect to the parent body segment or parent joint include compactness and efficiency. Another benefit of using relative pose accrues when the subject performs the same motion while facing different directions. In such a scenario, only the coordinates of the root joint or body segment that are w.r.t. to the world frame change. The coordinates for all other body segments or joints that are w.r.t. to their parents stay the same. This is advantageous for MLM/RNN 214 in its learning.

A 3D pose consists of a position or translation p and an orientation or rotation R in 3D. Position/translation is conveniently expressed as coordinates p=(x, y, z) w.r.t. an origin (0,0,0) in a 3D Cartesian coordinate system coinciding to a reference frame. When it comes to rotation/orientation R, there are multiple representation schemes including angles in radians or degrees, Euler Angles, Exponential Maps (angle-axis representation), 3×3 rotation matrices and 4-D Quaternions q=(x, y, z, w), among others.

Although any rotational representation can be used while taking advantage of the present technology, the use of quaternions is preferred for several reasons:
A quaternion q is a compact vector of four numbers.
For rotations, the magnitude of a quaternion is constrained to be of size one: |q|=1. This imposes a convenient bound in size and constraint on the search space for the components of a quaternion. In the present design, quaternions are used as a form of input to machine learning model 214 for training, and for inference at runtime or in other words, in production. This is because the choice of quaternions makes it easier for MLM 214 to learn patterns as a result of the reduced size of their representational space.
A rotation can be uniquely represented with only two possible quaternions, q and −q. This also makes a neural net such as MLM/RNN of FIG. 2A better able to learn from the limited of space rotation representations.

In contrast, Euler angles can represent a single rotation in an infinite number of ways, since any angle of rotation about a specific axis of rotation is equivalent to an angle of rotation that is a multiple of 360 degrees (or pi radians). While possible, this makes it harder to learn a mapping between body segment orientations and muscle activations if an infinite combination of body segment rotation coordinates can map to the same pose. Quaternions only allow the possibility of two quaternions for a body orientation. If one always chooses a convention such as picking the value where the w component of the quaternion is always positive, then one can uniquely specify a quaternion for any body orientation.

Referring now to FIG. 2A, the preferred embodiment uses one or more cameras or image sensors 204 to provide a series of images or a motion video or sensor data 205 to pose estimator 208. Pose estimator 208 produces a finite time-series 212 or X of pose estimates at points in time tᵢ where i=1, 2, . . . , n. Thus, time-series X consists of individual vectors Xᵢ produced at instances or points in time tᵢ at which the body movement or position and orientation of subject 202 was captured in pose estimate vector Xᵢ. Each vector Xᵢ consists of individual entries or values or elements Xⱼᵢ where j=1, 2, . . . , m represents body segments of interest configured into pose estimator 208 to be tracked via our set B discussed above.

Further, each pose estimate value Xⱼᵢ consists of a rotation R (represented in quaternions) of the corresponding body segment j w.r.t. a reference, which is preferably its parent body segment or alternatively its parent joint. Xⱼᵢ also contains a position or translation or position vector p of the corresponding body segment j w.r.t. a reference point. The reference point is in the parent body segment and located at local origin (0,0,0) of the frame of reference of the parent body segment. Therefore,

$${X}_{ji} = {( R , p )}_{ji}$$

Time-series 212 or X is finite and preferably uniform i.e. has uniform time intervals between the samples. It is output by pose estimator 208 for instances of times tᵢ at which input sensor data 205 was received or sampled by pose estimator 208. As shown in FIG. 2A, this time-series data is then supplied as input to machine learning model (MLM) 214 and which is preferably a recurrent neural network (RNN). As will be discussed further below, the model is first trained by providing it with the above time-series data for a variety of motion sequences of given subject as input, and the resulting muscle activations as output.

In a manner analogous to input time-series X, the muscle activation levels or simply muscle activations as the output of MLM/RNN 214 generate a time-series A. Thus, time-series A consists of individual vectors Aᵢ produced for points in time tᵢ at which input sensor data 205 was received or sampled per above. Each vector Aᵢ consists of individual entries or values or elements Aₖᵢ where k=1, 2, . . . , 1 represents muscles of interest configured into MLM/RNN 214 to be tracked. Note that each call to MLM/RNN 214 generates a vector Aᵢ and over time the time-series of such vectors Aᵢ is referred to as our output time-series A.

Time-series A is shown by reference numeral 216 in FIG. 2A. Analogously to pose estimator 208, the muscles of interest that need to be tracked are configured into MLM/RNN 214 by one of many possible configuration techniques, some of which were discussed above. Exemplarily, the number of muscles tracked in a human subject 202 by the system is 88 i.e. 1=88 above, although it can be any number up to and including all the muscles in the body. A single entry Aₖᵢ in vector A can also represent a muscle group consisting of several muscles. Each vector Aᵢ of time-series A can be stored or cached individually at a time. Alternatively, entire time-series A can also be stored/cached.

Many applications require estimating muscle activations only for a subset of muscles in the body. For example, one may only want to focus on muscles of the shoulder complex (such as, when analyzing a golf swing), or in the lower extremities or legs (such as, when evaluating squat exercises). Other biometrics such as ground reaction forces may be estimated to evaluate balance.

The values in a vector Aᵢ are preferably real numbers or float or double precision in the range of [0 . . . 1] with 0 designating no activation and 1 designating maximum or full activation. Alternatively, the values of Aᵢ may be discretized integer values, exemplarily in the range of [0 . . . 10] or even binary values [0, 1] depending on the implementation.

Based on the instant principles, system 200 and its MLM/RNN 214 can estimate muscle activations at real-time or near real-time rates or speeds. Per above, this speed/rate is at least 24 Hz i.e. MLM/RNN 214 can produce successive muscle activation estimates at a rate of greater than or equal to 24 estimates per second. This speed allows the system to have an almost real-time user experience. In other words, muscle activation estimates A are generated by MLM/RNN 214 by processing motion video or sensor data 205 fast enough to have a real-time perception for user/subject 202 and/or an observer/investigator (not explicitly shown).

Machine learning model 214 of FIG. 2A is first trained with training data comprising input=X based on a variety of input motion sequences of subject 202 and corresponding output=A of muscle activations. Once the model is trained per above, another motion sequence 205 of subject 202 is captured by cameras/sensors 204 and supplied to 3D pose estimator 208 at runtime. By runtime, we may also mean “in production” in some contexts. Regardless, pose estimator 208 then creates a time-series X′ of pose estimates for the various body segments j′ of interest. Note j′ may be a subset of the body segments j used in training above i.e. j′ j. The finite time-series data X′ is then provided to machine learning model 214. The model then analyzes this time-series data and based on its training above, infers or predicts an output time-series A′ of muscle activations at runtime.

As subject 202 continues to perform movements or motion sequences, model 214 continues to receive pose estimates X′ in a time-series from pose estimator 208 and continues to predict or infer output A′ in a time-series at runtime. Preferably, there are additional configuration options or parameters provided to system 200. These include a sliding window size W or more simply a sliding window W and an offset r within window W for MLM/RNN 214.

Sliding window size W instructs the MLM to process the input X during training and X′ in production, and estimate output A during training and A′ in production, using/through/in/over/via a sliding window of size W samples or frames or time instances of input data X. r is a fixed offset within W that is chosen according to an implementation and instructs MLM/RNN at which position within W of input X to choose the activation output A from. The best or optimal value of r is preferably learned experimentally for a given application.

Explained further, MLM/RNN 214 preferably estimates muscle activation output A over a sliding window W of pose estimates X and not just using a single pose estimate. Window W provides the MLM with the contextual information of input in order to generate the output. Offset r instructs MLM/RNN 214 where in window W over input X to generate output A. Choosing r such that it points to the middle of window W provides the model with both historical and future contextual information within W. This potentially improves the accuracy of output A or conversely, reduces its error. On the other hand, choosing r to point at the end of window W would provide MLM 214 with more history while no future context within input X for output A.

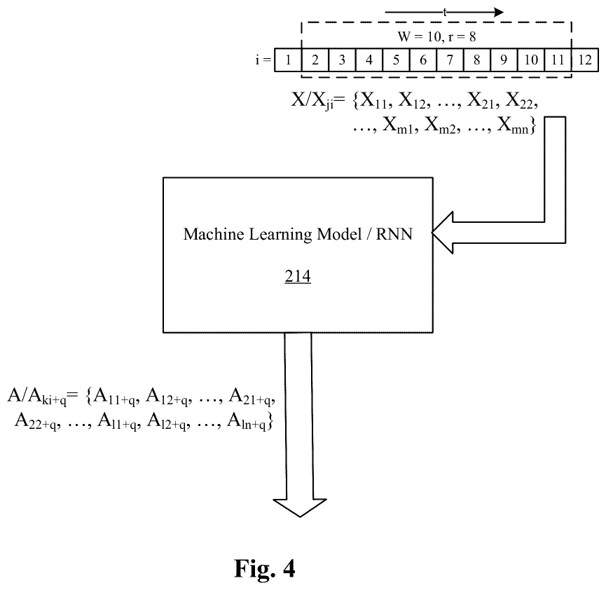

FIG. 4 further illustrates this concept. In FIG. 4, our MLM/RNN 214 of FIG. 2 is shown taking as input a time-series X of pose estimates and producing an output A of muscle activations using a sliding window W of size W=10, and offset r=8. Thus, output A is being chosen from near the end or more recent portion of window W in the shown example. More specifically, time-series X is shown comprising of individual values Xⱼᵢ={X₁₁, X₁₂, . . . , X₂₁, X₂₂, . . . , Xₘ₁, Xₘ₂, . . . , Xₘₙ} per above explanation. Model 214 processes these values using a window and offset of W and r respectively. Consequently, output time-series A comprises of individual values Aₖᵢ₊ᵣ={A₁₁₊ᵣ, A₁₂₊ᵣ, . . . , A₂₁₊ᵣ, A₂₂₊ᵣ, . . . , A₁₁₊ᵣ, A₁₂₊ᵣ, . . . , A₁ₙ₊ᵣ} with individual values Aₖᵢ within W offset by r.

The model can choose the output from any point in window W including the oldest or the most recent time instant or frame or anywhere in between. In some cases, it may even be chosen from outside of window W. In a preferred implementation, the output is chosen from near the end or from near the most recent frame of window W, for highest accuracy of output. Evidently, it is important that the model utilizes the same sliding window size W and offset r during production (or during deployment), as what was configured for its training. Another exemplary implementation utilizes W=20 and a value of r chosen from near the end of window W.

Pose sequence cache: As explained above, pose estimator 208 of FIG. 2A produces a time-series X of pose estimates of body segments of interest. The time-series is processed by machine learning model 214 over a sliding W window of time instances or number of frames/samples. To facilitate this, frames/samples in window W are stored in a queue such that older samples are pushed off the queue as newer samples are entered. Such a queue, referred to as a pose sequence cache, is optional to the main embodiments and is shown by reference numeral 210 in FIG. 2B. FIG. 2B is a variation 250 of system 200 of FIG. 2A. In the muscle activation system 250 of FIG. 2B, input time-series X of the above teachings is shown being provided from pose sequence cache 210.

The time interval between successive samples of the time series is preferably taken to be the same rate at which the system obtains image frames in the observed motion sequence. However, it may be longer if the pose estimator is slower in producing pose estimates than the rate of capture of its input motion sequence. This may also be the case if a lower temporal resolution/granularity of downstream processing is acceptable than the rate of capture of the motion sequence of subject 202 at input. The present technology can also be practiced with non-uniform time-series data, besides the uniform time-series data for our time-series X and A discussed above. However, many machine learning models that work with time-series data require uniform time intervals.

Muscle activity state mapper: Shown by reference numeral 218 in FIG. 2A-B, this optional module takes estimated muscle activation time-series A and maps it to a muscle activity state vector as its output 220. State vector or output 220 comprises elements that are discrete functions of time such that each function corresponds to an estimate of the activation level or activity of a muscle of interest at various points/instances in time. Output 220 is then used to drive a response system, which may be any type of response system, including an audio-visual response system as shown by numeral 222, a mechanical response system as shown by numeral 224, and the like. In its simplest form, mapper 218 can just pass through estimated activations 216 as its output 220. In such embodiments, it is muscle activation estimates 216 that directly drive any downstream response modules including response module 222 and 224 shown in FIG. 2A-B.

However, in other embodiments, mapper 218 allows original estimated activations A to be used to create new metrics or to be mapped to a range that can be used by various response systems or mechanisms. For example, muscle activations A may thus be mapped from the range of [0, 1] to another range of numbers [1, h], either linearly or non-linearly. Then, in audio-visual response module/system 222, these newly mapped values may be used to adjust the parameters of a visual cue. The cue may be a transparency of the picture to visually show fully-activated opaque muscles in contrast to inactive transparent muscles. They can also be used to index different texture patterns, color coding schemes such as a heat map or for any other visually modulated signal.

In another embodiment the time samples of the output muscle activation estimates may be filtered with a temporal filter to smooth the activation signals over time. Further, depending on the embodiment, the activations can also be used as input to functions that estimate new biometrics such as muscle fatigue, muscle force, metabolic cost and muscle energy used, which may provide new insights for motion relevant to a desired task. For example, one could use such a system to explain why a particular motion is too tiring or not efficient. The muscle activations can thusly also be transformed into control signals for a mechanical response module/system 224 shown in FIG. 2A-B or for any other response/output modality including vibration strength, audio pitch, light intensity, among others.

In another embodiment, muscle activity state vector or output 220 of mapper 218 can be used to configure a rigged 3D model or avatar model based on a human skeleton. In the same embodiment or a related variation, the rigged 3D model can be used as a part of a response system or module. For example, one can pose a human skeleton with such a rigged 3D muscle model attached to it.

Ground reaction force state mapper: Analogously to muscle activity state mapper 218 of FIG. 2A-B, some embodiments include a ground reaction force state mapper. This module (not explicitly shown in FIG. 2A-B), maps the time-series of ground reaction forces from one or more points of contact as estimated by MLM/RNN 214, into a state vector. This state vector comprises elements that are discrete functions of time such that each function corresponds to an estimate of the ground reaction forces on subject 202 at various points/instances in time. The state vector can then be used to drive a response system, which may be any type of response system, including an audio-visual response system as shown by numeral 222, a mechanical response system as shown by numeral 224, and the like.

In its simplest form, the mapper can just pass through the estimates of ground force reactions as its output. In such embodiments, the ground reaction force estimates directly drive any downstream response modules including response module 222 and 224 shown in FIG. 2A-B. In other embodiments, the values of the state vector can be used to compute other important biometrics such as joint stresses, balance, foot pressure and other useful indicators to evaluate the performed motions. The rest of the relevant teachings related to muscle activity state mapper 218 apply to this module also.

Audio-Visual response module/system: Various embodiments employ a visual/audio or audio-visual response system or module 222 shown in FIG. 2A-B. Per above, in some embodiments, this module is driven directly by muscle activation estimates 216 and/or ground: reaction force estimates. Preferably, it is muscle activation state vector 220 and/or ground reaction force state vector that are used as input for module or subsystem 222.

Depending on the variation, audio-visual response module 222 may have both audio and visual expression or output capabilities. Alternatively, it may just have a visual output capability and thus be a visual response module 222, or it may just have audio output capability and thus be an audio response module 222. Regardless of the variation, we will use the term audio-visual response system/module to refer to module 222 and will mean it to include either one or both of audio and visual capabilities.

Audio-visual response system 222 preferably uses a display device that maps its input to a visualization driven directly or indirectly by estimated muscle forces and ground reaction forces. The display can be a screen-based display such as a desktop display or a television (TV) or a display attached a reflective mirror. It can also be a hand-held display including the one on a smartphone or a mobile phone, or on a computing tablet device. It can also be an augmented reality (AR) display or a head-mounted display or any other type of display whether that is wearable or not.

In other embodiments, audio-visual response system 222 is a light-based display system, exemplarily containing light emitting diodes (LEDs). In some embodiments, the LEDs are attached to wearable clothing. Alternatively, other lighting elements that light up on parts of the body where high muscle activity is estimated may also be used. The patterns of light can vary with color, pulsing frequency or intensity. They may even form stylistic spatial patterns for both aesthetic and functional expression.

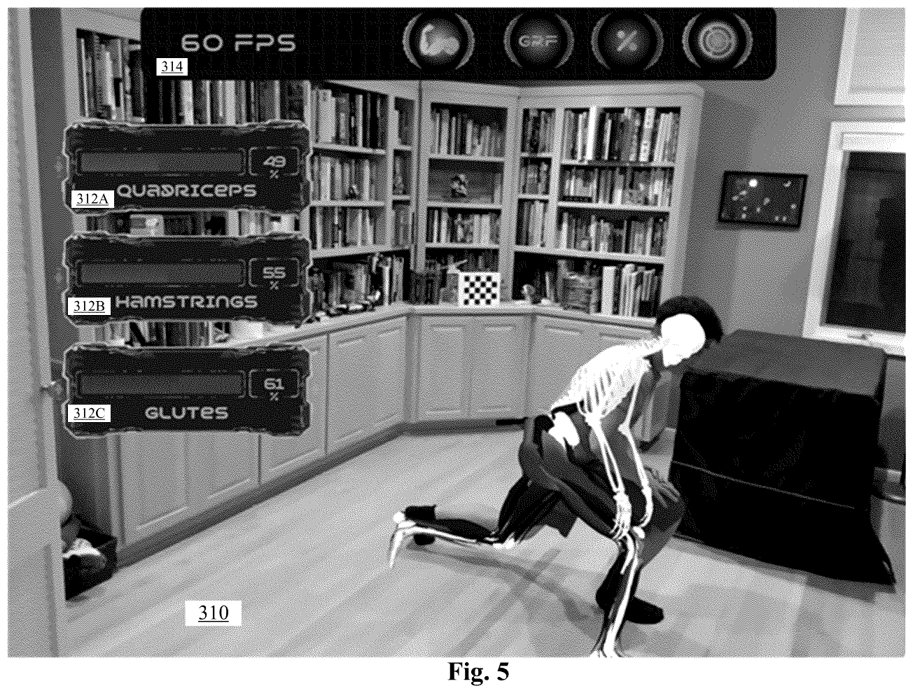

One embodiment uses a hand-held display with a rear-facing camera, exemplarily on a smartphone or a tablet. The device is held by an observer with a live video feed from the rear-facing camera pointed at the subject and the corresponding visualization of muscle activation appearing on the display in real-time. Using augment reality (AR) techniques, 3D representations of the muscles can be superimposed on a skeleton. The superimposed muscles can be color-coded based on the degree of activation of the respective muscles. A snapshot 310 from the visualized output of such an embodiment is shown in FIG. 5.

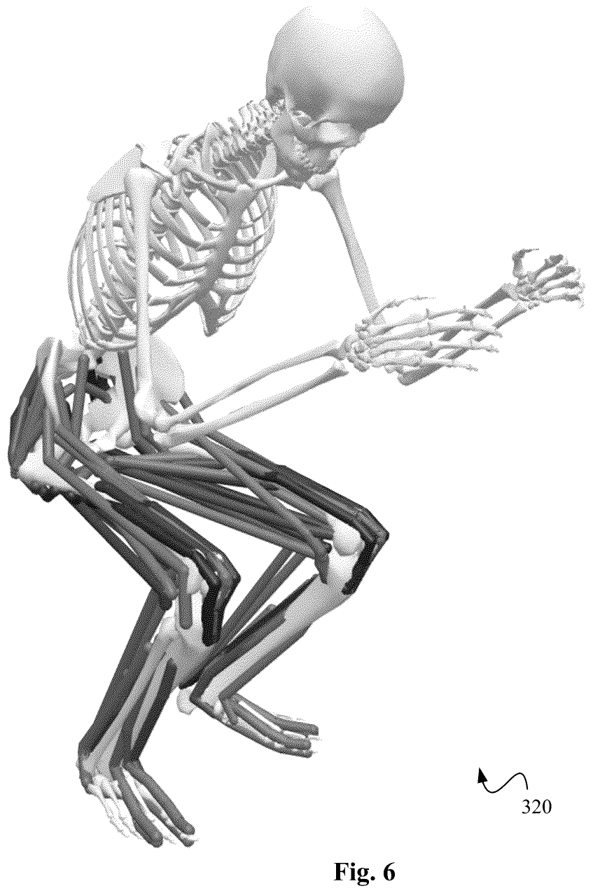

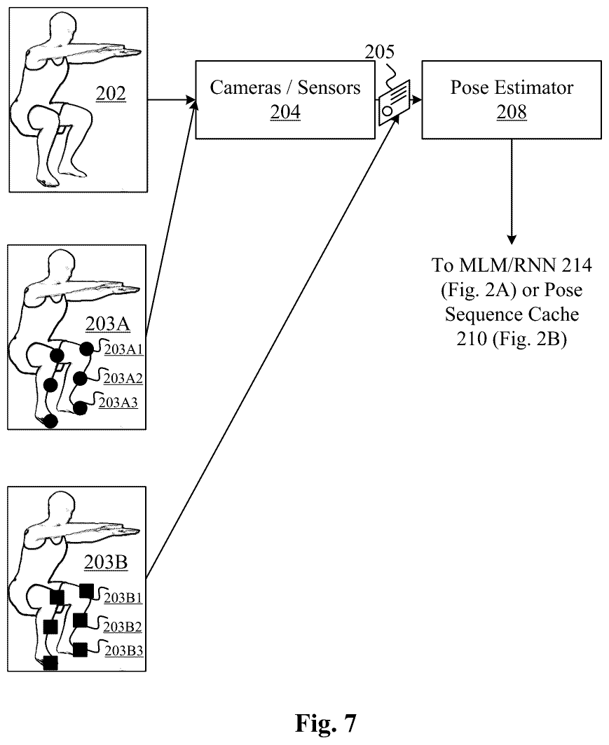

Depending on the embodiment, the muscles can be shown on a 3D deformable model of varying degree of anatomical accuracy of the muscle shape. This can range from the overall envelope of the muscle and tendon groups, to individual muscle bundles, to pennation patterns of differing muscle fiber orientations. Again, depending on the embodiment, the muscles can also be abstracted as connected line segments indicating the line-of-action of muscle force. An example of such a visualization 320 using piece-wise line segments depicting muscle activations is shown in FIG. 6.

In still other embodiments, the values of estimated muscle activations directly or the respective muscle activity state vector, is used to update various UI screen elements such as sliders, graphs, button states, text fields and the like. Examples include horizontal UI sliders 312A, 312B, 312C and various indicators/gauges shown in panel 314 in FIG. 5. In yet other embodiments, the visualization is cast/broadcast to an external monitor or to a reflective mirror with a display to allow the user performing the motion to observe themselves. Such a setup provides them with direct feedback on their motions and resulting muscle activations and other biometrics. The visualization is preferably expanded to include time series graphs or other AR overlays over the live video feed on the display.

Yet another implementation utilizes a head-mounted display on which the subject/user can monitor their own motions and the visual cues for muscle activations and other biometrics in a hands-free manner, while performing the motions unencumbered. A related embodiment uses an AR display/interface that superimposes a posed skeleton. Based on the input motion sequence of the pose of subject 202 in FIG. 2, the AR display superimposes the skeleton with 3D muscles having color coding based on levels of activation of the muscles.

In another embodiment, the system only shows a subset of muscles that are relevant to the task being analyzed. This avoids overwhelming the user with too much information such as by showing inactive muscles or muscles on body parts not relevant to the task. In another embodiment, the activations are provided as input to various functions that create enhanced visual differentiation that allow the user to more easily see changes or differences in activations.

In another embodiment, activation estimates A shown by numeral 216 in FIG. 2A-B and/or corresponding muscle activation state vector 220, control a software user interface (UI) based on body motions. For example, the software is a virtual reality painting program in which the intensity or color of 3D strokes is based on body motions. In another embodiment, the activation of various muscles is mapped to different musical instrument sounds. This allows the body to be used as a full-body musical instrument capable of producing instrument sounds depending on which muscles are activated. Preferably, this further allows the motion of the body segments to modulate the timing, pitch and rhythm of the music.

In yet another embodiment, an animation application is driven by estimated muscle activations 216 or state vector 220 to drive a character animation rig that animates the muscle-based skin deformations of a real-time animated character. One could animate realistic subtle body shape changes such as bulges in the skin with contracting muscle(s), tendon(s) being pulled tight preceding a limb motion, and showing muscle(s) under strain with effort, among other effects. For accomplishing such effects, prior art attempts required lengthy simulations at non-interactive speeds/rates.

In yet another embodiment, the estimated muscle activations or state vector 220 are used to create sounds in a musical instrument or some other sound-making device for the expression of auditory experiences. The auditory expressions can be used for the creation of music or as auditory feedback for motion correction. In related embodiments, the sounds are used as a form of auditory communication with auditory coded signals of specific tones/frequency. Alternatively, the sounds are even mapped to a known language to allow communication through body expression in a similar manner as American Sign Language for non-verbal communication.

Mechanical response system: Muscle activation and/or ground reaction force estimates, or their respective state vectors discuss above can also be used to produce one or more control signals that drive or actuate a mechanical response system 224 shown in FIG. 2A-B. As noted above, in the simplest case, estimated muscle activation time-series A denoted by numeral 216 in FIG. 2 and/or the estimated time-series of ground reaction forces, can directly drive such a response system 224. In one embodiment, response system 224 is an exoskeleton suit. In such an embodiment, the muscle activations or corresponding state vector is used to compute control signals for the suit indicating which joints may require external motor assistance from the suit. Note that those response modules/systems with both mechanical as well as audio and/or visual expression capabilities can be considered as either or both of audio-visual response module 222 and mechanical response module 224.

In another embodiment, response module/system 224 is a prosthesis worn by user 202 on a limb that has motors and which are actuated based on control signals derived from muscle activations or their state vector. Such h a prosthetic device can thus actively stabilize, assist, enhance or counter a body motion of the user. In related embodiments, depending on the shape of the prosthetic and body tracking algorithm used, the prosthetic limb can be used to help estimate a body pose in lieu of the missing physical limb. The consequent muscle activation estimates produced by the system can aid as a control signal for the prosthetic device in order to help signal the motor intentions of the user.

In another embodiment, response system 224 is an external robotic device, that puppets or mimics the body motions of user 202. In another embodiment, the activations and/or state vectors are used to derive signals for haptic motors or vibration motors embedded and/or worn by the user. Such a setup provides haptic feedback and stimulation to help guide the user to use specific muscles on their body for training or rehabilitation purposes. The user can use the stimulated vibrations to remind them as to which muscles they should be actively trying to utilize.

In FIG. 2A-B, the cameras/sensors are used to obtain measurements from a person or animal performing the motion. Image sensors or cameras are preferred that can sense multiple modalities such as color and/or depth. The image is usually represented as a 2-dimensional array of values of more than one channel of information.

Channels include multi-bit precision representations of color such as red, green or blue channels or other encodings of color such as RGB, L*a*b and HSB. Channels can also include estimates of depth of an observed surface to the camera sensor. The resolution of the image sensor determines the number of pixels or samples of the image taken from a specific viewpoint. The advantage of image sensors or cameras are they do not require the subject performing the motion to wear any biometric sensors, control units, wires or other devices to take measurements. This allows unencumbered motion.

The subject is also capable of performing the motions a distance away from the camera, avoiding possible interference or collisions between the camera and the subject. It also provides more freedom of location to perform the motion, allowing one to leave the confines of an indoor lab that might have special apparatus or environment markings. The subject is free to move outdoors or in a normal home environment. They can also move in a space of limited or expansive volume. One can potentially utilize the camera with other worn sensors or physical markings on the subject to improve the accuracy and modalities of information sensed. Such sensors include those that can obtain heart rate and temperature, though they are not necessary for the main embodiments of the technology.

The preferred embodiment uses a single viewpoint of the subject by utilizing a single camera. However, alternative embodiments support multiple viewpoints captured in images/videos taken by multiple cameras. Intuitively, such multiple viewpoints would result in a higher accuracy of data for the machine learning model 214 of FIG. 2, both for training and for production.

Furthermore, other computer vision and machine learning techniques can use multiple viewpoints and produce high-accuracy pose estimates. For this purpose, additional sensors or features/markers on subject 202 may be utilized.

A series of images or a motion video is preferably captured by a camera and then provided as input to a 3D pose estimator that estimates the body poses. The pose estimator may utilize one or more of a number of techniques. In alternative embodiments, readings/measurements from inertial measurement unit (IMU) sensors including an accelerometer placed/held on/by the subject may be used by the pose estimator for estimating the 3D poses. In a variation, both the images/motion video and IMU/sensors may be utilized. In still another embodiment, visual markers on reference points or features on the body of the subject are identified/tracked using computer vision techniques utilized by the pose estimator for estimating the pose.

FIG. 7 shows additional embodiments that take advantage of such approaches. More specifically, FIG. 7 shows many variations of FIG. 2. In one variation, there is a subject 203A with markers 203A1, 203A2, 203A3 and so on, placed on the body of the subject. Only three such markers are shown marked by reference numerals to avoid clutter. These markers may be passive or active markers and produce easily observable features on the body to identity body segments and to calculate their poses from the images or motion videos by cameras or images or camera system 204.

These images or motion videos are then provided as sensor data 205 and input to pose estimator 208 of the earlier teachings in reference to FIG. 2. Pose estimator 208 computes pose estimates of body segments of interest of subject 203A, which are then provided directly to MLM/RNN 214 of FIG. 2A or via pose sequence cache 210 of FIG. 2B. The rest of the flow in FIG. 7 continues as per FIG. 2A-B discussed above.

In another embodiment illustrated with the aid of FIG. 7, instead of or in addition to cameras or images sensors or camera system 204, wearable sensors 203B1, 203B2, 203B3 and so on are worn by subject 203B. Only three such sensors are marked by reference numerals to avoid clutter. These sensors may be of various types and comprise accelerometers or inertial measurement unit (IMU) sensors. Sensor data 205 output from these sensors is provided to 3D pose estimator 208 as input. Pose estimator 208 computes pose estimates of body segments of interest and the rest of flow continues per above.

In a variation, the IMU is placed on a stable part of a body segment to directly measure the position and orientation changes on a body part with respect to a fixed initial pose to estimate body segment orientations. This may be desirable if one wishes to estimate muscle activations without the need of an external camera or observer. For example, if the subject is wearing an exoskeleton suit or an item of smart clothing, then using wearable sensors would allow muscle activations to be estimated in order to derive a control signal that ultimately drives the mechanisms or displays of the suit/clothing in a self-contained manner.

For non-invasive methods, there are classes of machine learning algorithms that take the image data as input (represented as a 2-D array of multi-channel vector information from each pixel of the image) into a neural network of various architectures. Exemplarily, such architectures include a convolutional neural network (CNN) that produces as output a hierarchical representation of the body segments, the joints between them and the pose of each joint.

Per above, the pose of each joint can be with respect to the inboard parent of the joint which is the body segment that is proximal to the torso. It can also be with respect to another external reference frame, typically referred to as the world reference frame in the environment. It can even be the frame of the observing camera. For most biomechanical joints and as noted above, we can assume negligible translation between the bones and ignore the translational coordinates of the joint, allowing only rotations to be represented in such embodiments. However, in cases of dislocation of joints, the translational movement is important and is not ignored in related embodiments.

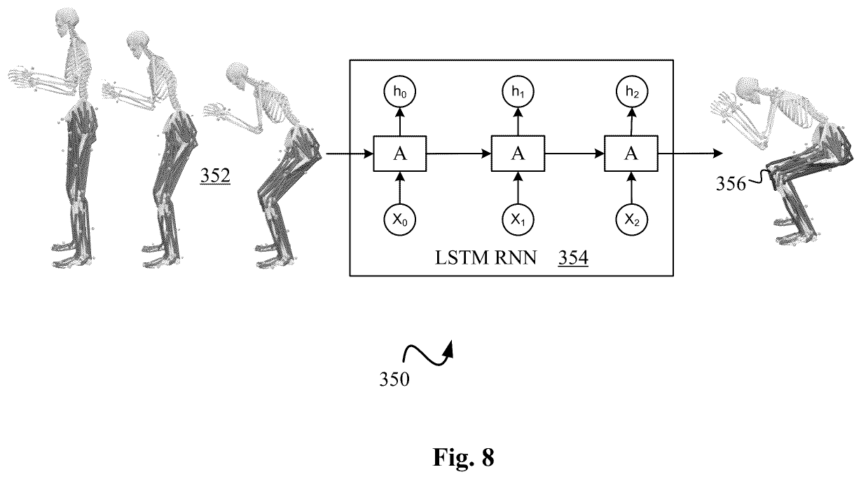

Machine Learning Model 214: The preferred embodiments use a recurrent neural network (RNN) as machine learning model (MLM) 214 for FIG. 2. RNNs are well suited for time-based data, such as the time-series data used by the instant techniques and per above discussion. While MLM/RNN 214 of the present technology can be implemented using various types of RNNs, best results have been achieved by utilizing a long short-term memory (LSTM) RNN or LSTM RNN. FIG. 8 shows an embodiment 350 with time series of poses 352 as input into to an LSTM RNN 354 for estimating muscle activations 356 at a given instant of time.

While referring back to FIG. 2, time-series data including motion video or images 205 captured by cameras/sensor 204 and time-series 212 of pose estimates provided to MLM/RNN 214 in FIG. 2 affords many advantages. These include providing spatiotemporal context and history for machine learning. Many phenomena, such as muscle activations are influenced by the local history of state changes that preceded it. Similarly, if one observes the state changes that occur later in time, one can obtain a better estimate of a biometric value at a particular time preceding it. This is the case for muscle activations because the neural excitation signal from a motor neuron in the neuromuscular system releases chemicals that induce muscle fibers to contract and cause motion to occur over a finite time period.

There is also finite time latency between the instance when a message from the brain travels through the nervous system to the motor neuron (the start of muscle activation) and to the beginning of muscle fibers contracting and physically causing motion in the bones attached to it. So, the beginning of buildup of muscle activity can precede the actual onset of observable motion in the limbs. This is why it is more useful to consider a sliding window W of time series pose samples and not just a single pose at a single instance in time. Recall the above discussion in reference to sliding window W and offset r.

Machine learning model 214 is critical for providing a very fast inference estimate of muscle activations and ground forces at real-time rates e.g. greater than or equal to 24 Hertz (Hz) or estimates per second. The preferred architecture using neural networks consists of multiple layers of nodes with weighted connections and where the weights are learned through training. The training is important for producing good quality inferences or predictions during production or run-time.

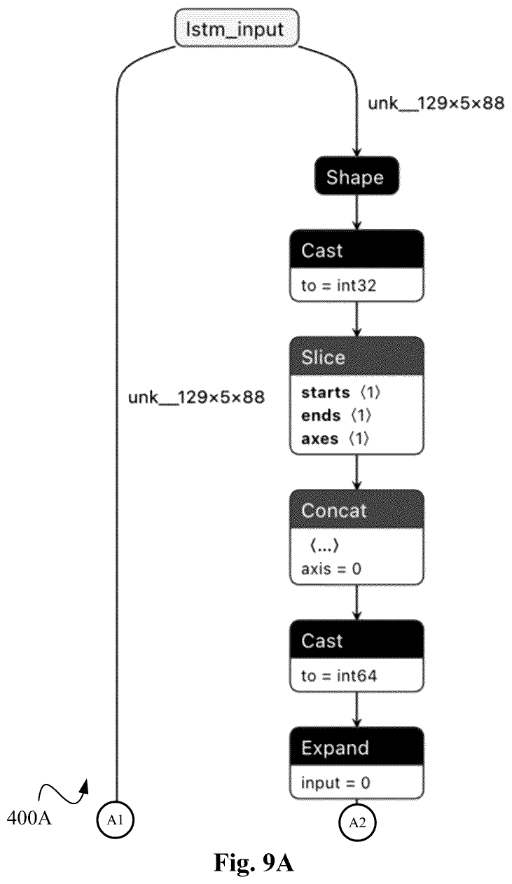

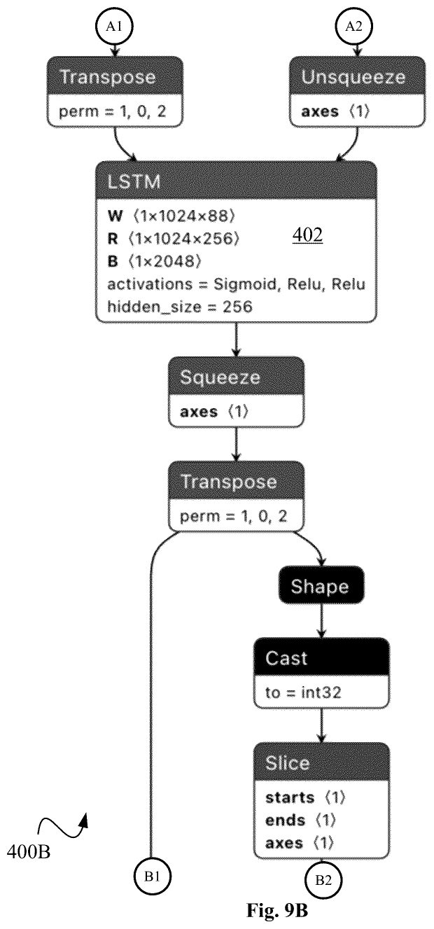

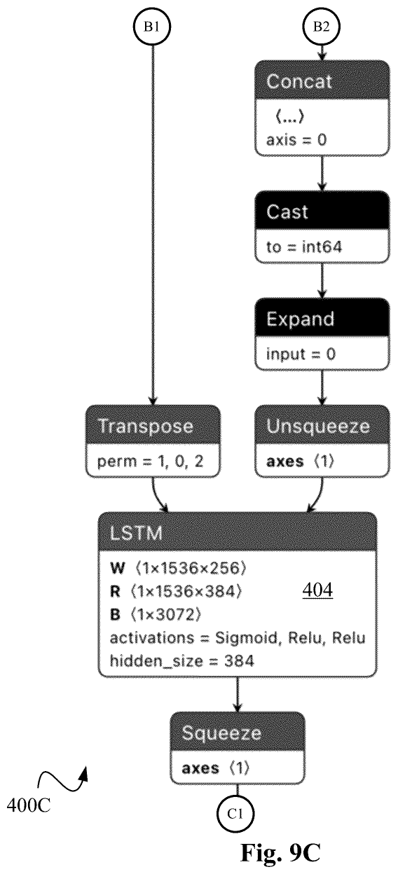

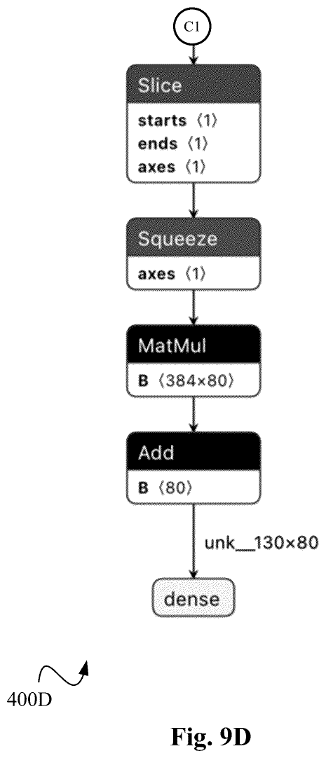

A preferred embodiment utilizes such a multi-layered LSTM RNN or simply a multi-layered LSTM network 400 as shown in FIG. 9A-D. Network 400 maps the body segment orientations stored in the input labelled “lstm_input” and produces activations stored in the output labelled “dense”. The top-down illustration of neural network diagram 400 of FIG. 9 has been split into four drawing figures FIG. 9A-D for better legibility. More specifically, the topmost portion 400A of the LSTM RNN network diagram in FIG. 9A connects to next lower portion 400B in FIG. 9B, at or via connections/connectors A1 and A2 shown in FIG. 9A-B. Portion 400B illustrated in FIG. 9B connects to next lower portion 400C in FIG. 9C, via connections B1 and B2 in FIG. 9B-C. Portion 400C in FIG. 9C connects to bottom portion 400D in FIG. 9D, via connector C1 of FIG. 9C-D.

Other types of networks capable of accepting time-series of inputs that may be utilized for machine learning model 214 of FIG. 2 include other recurrent neural networks besides LSTM RNNS, transformer networks and even dense connected networks or DenseNet.

In a preferred implementation, Python programming language is used to prepare the data for training and input to our MLM/RNN. The MLM/RNN in this disclosure is also sometimes simply referred to as “network” and is not to be confused with a communication network. Using Python, the data is preferably batched for training and cross validation of the network. Per above, the pose estimates to MLM/RNN are then provided in time-series X using a sliding window W with offset r, and the resultant muscle activation estimates are obtained as time-series A.

MLM/RNN of the present design is preferably created using available machine learning frameworks such as the open source Python-based TensorFlow™. This framework automatically computes gradients that can be used for backpropagation-based learning of weights with a loss function. The loss function is designed to minimize the error between the training outputs and the inferred outputs of the network with the training inputs. The framework also supports central processing units (CPUs), graphics processing units (GPUs) and tensor processing units (TPUs), thus allowing for highly parallel hardware acceleration.

A higher-level Python-based application programming interface (API) called Keras built using TensorFlow™ is preferably used to specify the architecture of the instant MLM/RNN of the present teachings. Multiple LSTM layers can be added to the model using Keras API calls. For instance, in model portions 400B and 400C depicted in FIG. 9B and FIG. 9C respectively, two LSTM layers were added as shown by nodes 402 and 404 labelled “LSTM”. Note, that not all the nodes in network 400 of FIG. 9 are marked by reference numerals for brevity. This is because common operations identified by nodes such as those labeled “Shape”, “Cast”, “Transpose”, “Slice”, “Concat”, “Expand”, “Unsqueeze” and others will be familiar to a person skilled in TensorFlow™. The Keras layer is also preferably used to expose parameters to adjust the size of the LSTM network and to specify any other hyperparameters required for customizing the network.

Collection of Training Data and Model Training: MLMs/RNNs 112 of FIG. 1A-B and 214 of FIG. 2A-B are trained using a training data set comprising time-series of poses paired with muscle activations and/or ground reaction forces measured or estimated for those poses. The machine learning model is trained using actual/measured or simulated muscle activation data and ground reaction force data. One exemplary platform for realizing such simulated data is OpenSim, short for Open Simulator.

The training dataset can be synthesized or created from biomechanical numerical simulations using human or animal models by solving for estimates of muscle activations and/or ground reaction forces based on optimization techniques. Biomechanical simulation is an important technique for extracting information about non-superficial muscles, i.e. muscles not close to the skin. This is because current Electromyogram (EMG) sensors cannot reliably measure activity of those internal muscles and any direct sensors would be invasive and may interfere with the motion produced by the subject.

In order to learn muscle activations and other biometrics such as ground reaction forces, a training dataset is created. The training data can be simulated rather than measured from a live subject. The training dataset consists of a mapping of an input time-series X of estimates of body segments of interest to an output time-series A of estimates of activations/activity of muscles of interest. In industry literature, the letter Y is generally used to denote a predicted or inferred output from a machine learning model. Thus, we can say that the training dataset consists of an input X and an output Y that consists of muscle activations A in the preferred embodiments.

In related embodiments, output Y further includes or consist of a time-series G of vectors Gₛᵢ of ground reaction force estimates based on input time-series X. Here, s=1, 2, . . . u represents points of contact of interest of the body of the subject with the ground. Per above teachings, i=1, 2, . . . n are the timestamps of the samples or vectors of input data Xᵢ of pose estimates in time-series X. Depending on the embodiment, output Y may include or consist of any other output of interest that may be predicted/derived from inputs X.

The direct measurement of such biometric quantities is often either too invasive to the subject or is likely to alter the desired motion that we wish to analyze. Therefore, they are typically simulated using a physics simulator in conjunction with a model of the biomechanical system of the subject. Similarly, muscle activations for corresponding pose inputs X may also be simulated based on a biomechanical model, rather than measured using a live subject.

Such a biomechanical model incorporates the mass and physical properties of bones, body segment mass and inertia as well as attachment points of muscles, ligaments and tendons on bones. It also incorporates attachment sites of the body as well as estimates of the maximum physiological force a muscle can generate. Then, numerical optimization methods are used to find the sequence of muscle activations that can generate sufficient muscle force and subsequently joint torque to induce a prescribed motion. By solving the optimization problem for a given sequence of pose samples, we obtain an estimate of muscle activations and other physics-derived quantities such as the ground reaction and joint reaction forces. Based on this approach, we arrive at training datasets for models 112/214 of FIG. 1/FIG. 2 that are simulated rather than measured.

Given that the biomechanical model has mass and inertia properties described for all the body segments and given we know the pose of the body as well as the force of gravity and any other external loads on the body and specifically each bone, we can estimate the ground reaction forces G of the ground acting on the body. We can also compute the joint reaction forces necessary to maintain the body joint in place with a physical simulator.

However, the computational expense associated with the numerical optimization for creating the above simulated data can be high. This is at least because the optimization is typically done iteratively in order to achieve convergence. As a result, the process of creating simulated data is slow and cannot be done in real-time in response to input data X. The above dynamic simulation can be performed using a variety of software. One popular example is the OpenSim software framework for modeling, simulating, controlling and analyzing the neuromusculoskeletal system as available at http://simtk.org.

The present technology takes the solutions of these simulations and optimizations and encodes the computed muscle activations and ground reaction forces into a training dataset for the MLM such as MLM/RNN 214 of FIG. 2A-B. This results in fast prediction and inference in production or at runtime given the body pose input time series X as input. The computational time to perform the inference at runtime can occur at real-time or near real-time speeds, thus providing immediate feedback to user/subject 202 or to an observer/investigator.

Once the training data set is created, it is then provided to an instant LSTM RNN machine learning model which goes through a learning process to train the weights of the network until evidence of learning occurs. Further, in a manner similar to the training, a validation data set is also created. During training, the MLM seeks to minimize the loss function that measures the error between inputs X and predicted outputs Y compared to the provided outputs of the training set.

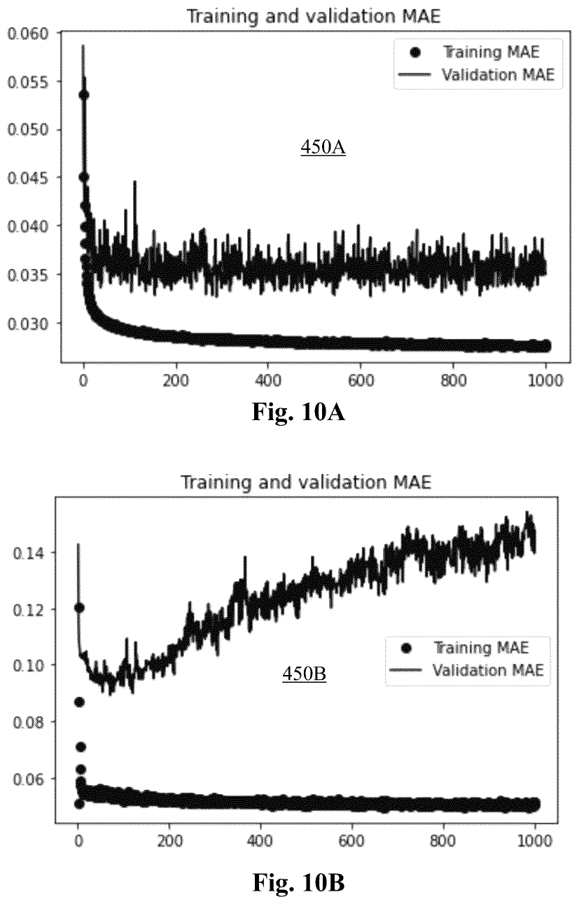

Care must be taken during this stage to avoid overfitting situations 450A and 450B as shown in FIG. 10A and FIG. 10B respectively. In FIG. 10A-B, MAE represented on the Y-axis is the mean absolute error (MAE) between training and validation data and the X-axis represents the training epochs. In the case of overfitting, the network performs very well with the training data but fails to generalize well and plateaus in performance with the validation data as seen in FIG. 10A. In FIG. 10B, the network has become too specialized to the patterns of the training data, and can no longer generalize well to the validation data.

The validation data is not used in the original training and hence has never been encountered by MLM/RNN 112/214 of FIG. 1/FIG. 2 before. As a result, the large MAE in the performance for validation data is evidence of the poor generalizing ability of the inference. The training MAE gradually decreases to a small value as training epochs increase, but the validation data does not show the same downward error trend. The reason is that the network trained itself to only do well with the training data and was not able to generalize properly.

In the case of an underfitting situation, the network is unable to predict well for both training and new test data. This is because the weights have not been trained long enough to create accurate inference/predictions for the intended input data. This can also be because the model is too simple due to insufficient number of network layers, nodes or connections and cannot represent the features well. The features are needed to learn and generalize the mapping of inputs to outputs.

Based on the present principles, the order in which the training data is presented to machine learning model 112/214 is important for generalized learning. If all the datasets from the same types of motions were to be presented to the model together or consecutively, this would bias the training of weights to overfit to that particular specific motion. On the other hand, if one were to mix up the motions so that a variety of motion sequences from different types of motion are interleaved in the training, the weights can be adjusted in a balanced manner, thus increasing the chances that the weights represent generalize learning.

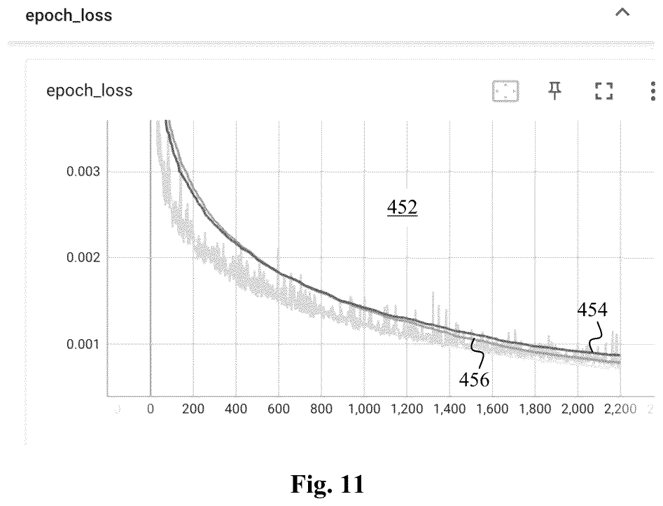

Instant training of model 112 and 214 of FIG. 1A-B and FIG. 2A-B interleaves the training set data with a variety of motions and preferably from different subjects. This forces the network to continuously maintain a lower loss function for a wide range of different motions with the same set of weights. The result is a trained model that is generalized enough to infer/predict output Y for unseen data X with improved accuracy. FIG. 11 shows a performance graph 452 of such a generalized trained model. In FIG. 11, curve marked by reference numeral 456 represents performance with validation data with a downward trend in error alongside performance curve 454 with training data. This indicates that the network is able to generalize its learning since the validation data set was not used in training.

Although the preferred embodiments do not require any external apparatus and allow the subject to move freely, there are times when it might be desirable to build a training dataset with a wider variety of input conditions. Thus, depending on the embodiment, the training data inputs are augmented with external loads such as ground reaction forces, or other external weights applied to the body. Examples include barbells being carried by the subject and/or a weighted vest being worn by the subject, and/or a backpack being carried by the subject, among others. Based on the instant design, MLM/RNN 214 of FIG. 2A-B which is preferably an LSTM, can adapt for predicting muscle activations under varying external loads. These muscle activations are different when the subject performs the same motions but under different conditions.

In another embodiment, by being able to estimate ground reaction forces, one can differentiate whether the body of the subject is in contact with the ground or is in flight. This allows muscle activation predictions to be adjusted and differentiated in those two different motion phases. In still another embodiment, by including motion sequences from a variety of different subjects in the same training set, MLM/RNN or network 214 can learn to adapt to different body types. These include differing height, weight, body segment mass distributions, body segment lengths, circumferential distance around the limb, among others. As a result, network 214 becomes more adaptable for different body types.

In another embodiment, a pose detection system can be used that can detect multiple subjects in a scene to observe multiple subjects interacting together and observing their collective muscle activity patterns together. This can be useful for multi-people activities including wrestling, martial art sparring over dancing among others.

Per above teachings and depending on the embodiment, the MLM can also optionally estimate ground reaction forces which represent the external forces of the ground applied to parts of the subject body in contact with the ground. In another embodiment, these ground reaction forces can potentially be fed back into the MLM to improve its performance for estimating muscle activations. The ground reaction forces can also be used to infer foot pressure and balance distribution of weight. In conjunction with estimates of muscle activations and muscle forces (which can be computed from the muscle activations), one can also calculate the joint reaction loads. These represent the mutual contact forces acting on the bones at a joint.

In yet another embodiment, it is desirable not to estimate the full 3D ground reaction force, but simply the vertical ground reaction force which is normal to the plane of the ground. This is useful as it does not require knowledge of an external coordinate system to specify the directions relative to the world. It also simplifies the size of the ground reaction output data of/for MLM 214 of FIG. 2A-B. Yet, it still provides a good indicator of the amount of weight being applied at the contact point with the ground.

An exemplary hardware environment for practicing various software systems, sub-systems and modules of the present embodiments either locally or remotely comprises a hardware configuration of an information handling/computer system. The system comprises at least one processor or central processing unit (CPU) for executing the program instructions of the embodiments described herein. The CPUs are interconnected via a system bus or via other interfaces to various devices such as a random access memory (RAM), read-only memory (ROM), and an input/output (I/O) adapter. The I/O adapter can connect to peripheral devices or other program storage devices that are readable by the system.

The system can read the inventive instructions on the program storage devices and follow these instructions to execute the methodology of the embodiments herein. The system further includes a user interface adapter that connects a keyboard, mouse, speaker, microphone, and/or other user interface devices such as a touch screen device connected to the bus to gather user input. Additionally, a communication adapter connects the bus to a data processing network, and a display adapter connects the bus to a display device which may be embodied as an output device such as a monitor, printer, or transmitter, for example. Variations of the above configuration are also conceivable.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood t the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

In view of the above teachings, a person skilled in the art will recognize that the methods of present invention can be embodied in many different ways in addition to those described without departing from the principles of the invention. Therefore, the scope of the invention should be judged in view of the appended claims and their legal equivalents.

What is claimed is:

1. A system comprising:
(a) a camera for capturing a motion video of a subject, said subject comprising a body segment and a muscle;
(b) a pose estimator for analyzing said motion video and for generating a time-series of three-dimensional (3D) pose estimates of said body segment, wherein said pose estimates are relative to a parent body segment; and
(c) a trained recurrent neural network (RNN);
wherein said trained RNN receives said time-series and generates an estimate of an activation of said muscle.

2. The system of claim 1, wherein said trained RNN is a trained long short-term memory (LSTM) RNN.

3. The system of claim 2, wherein said trained LSTM RNN processes said time-series through a sliding window.

4. The system of claim 3, further comprising an audio-visual response module for performing a visualization of said activation based on said estimate.

5. The system of claim 4, wherein said audio-visual response module utilizes a screen for said visualization, said screen belonging to one or more of a video playback system, a desktop computer system, a mobile computing device, a tablet, a wearable augmented reality (AR) display, a head-mounted AR display and a reflective mirror.

6. The system of claim 4, wherein said audio-visual response module comprises wearable clothing containing light emitting diodes (LEDs) for said visualization.

7. The system of claim 3, further comprising an audio-visual response module for generating one or both of a character animation and a sound based on said estimate.

8. The system of claim 3, further comprising a mechanical response module that is actuated based on said estimate.

9. The system of claim 8, wherein said mechanical response module is one of an exoskeleton suit and a wearable prosthesis, and wherein one or more limbs of said mechanical response module are actuated based on said estimate.

10. A system comprising:
(a) a sensor for generating sensor data by sensing a motion of a subject, said subject comprising a body segment and a muscle;
(b) a pose estimator for analyzing said sensor data and for generating a time-series of three-dimensional (3D) pose estimates of said body segment; and
(c) a trained recurrent neural network (RNN);
wherein said trained RNN receives said time-series and generates an estimate of an activation of said muscle.

11. A method comprising the steps of:
(a) capturing a motion video of a subject by a camera, said subject comprising a body segment and a muscle;
(b) analyzing said motion video by a pose estimator and generating by said pose estimator a time-series of three-dimensional (3D) pose estimates of said body segment relative to a parent body segment; and
(c) processing said time-series by a trained recurrent neural network (RNN) and generating by said trained RNN an estimate of an activation of said muscle.

12. The method of claim 11, wherein said trained RNN is a trained long short-term memory (LSTM) RNN.

13. The method of claim 12, configuring said LSTM RNN to use a sliding window and offset for said generating.

14. The method of claim 12, further generating by said trained RNN more than one of said estimate at a rate greater than or equal to 24 Hertz.

15. The method of claim 14, visualizing by an audio-visual response module said activation based on said estimate.

16. The method of claim 15, utilizing a screen by said audio-visual response module for said visualizing, said screen belonging to one or more of a video playback system, a desktop computer system, a mobile computing device, a tablet, a wearable augmented reality (AR) display, a head-mounted AR display and a reflective mirror.

17. The method of claim 15, lighting light emitting diodes (LEDs) for said visualizing.

18. The method of claim 14, driving a mechanical response module based on said estimate.

19. The method of claim 18, providing said mechanical response module to be one of an exoskeleton suit and a wearable prosthesis, and actuating one or more limbs of said mechanical response module based on said estimate.

20. The method of claim 18, providing based on said actuating one or both of a vibration feedback and a haptic feedback to said subject.
